(19) United States
(12) Patent Application Publication
(10) Pub. No.: US 2019/0363665 A1
(43) Pub. Date: Nov. 28, 2019

(54) CONTROL SYSTEM ENSURING PROTECTION AGAINST THE SHORT-CIRCUITING OF A ROTARY ELECTRICAL MACHINE RECTIFIER BRIDGE

(71) Applicant: Valeo Equipements Electriques Moteur, Creteil (FR)

(72) Inventors: Pierre Chassard, Creteil (FR); Laurent De Lamarre, Creteil (FR); Pierre-François Ragaine, Creteil (FR); Farouk Boudjemai, Creteil Cedex (FR); Mohamed Gaci, Creteil Cedex (FR)

(73) Assignee: Valeo Equipements Electriques Moteur, Creteil (FR)

(21) Appl. No.: 16/419,451

(22) Filed: May 22, 2019

(30) Foreign Application Priority Data
May 22, 2018 (FR) 1854237

(51) Int. Cl. H02P 29/024

(52) U.S. Cl. CPC H02P 29/0241

(57) ABSTRACT

A system for control of a polyphase rotary electrical machine includes a stator provided with a plurality of phases, a synchronous rectifier bridge with a plurality of branches, each associated with a phase, each branch comprising a high transistor and a low transistor, a circuit for control of the high transistor, which can control a state of the said high transistor according to a difference between the positive potential and a reference voltage relative to the phase, a circuit for control of the low transistor, which can control a state of the said low transistor according to a difference between the phase voltage and a reference voltage relative to the negative potential, and, for each phase, a first protection device which is configured to permit a command for the low transistor to go to the switched-on state only if the phase voltage is lower than a threshold voltage.

The present invention relates to a control system ensuring protection against the short-circuiting of a rectifier bridge of a rotary electrical machine.

In a motor vehicle, an on-board network is used to supply the different electrical consumers with which the vehicle is equipped. The power is supplied by at least one battery. The battery is recharged thanks to a rotary electrical machine, from energy supplied by the rotation of the thermal engine of the vehicle. Rotary electrical machine means more generally any polyphase rotary electrical machine which is used for the production of direct current supplying power to the on-board network. In particular, the machine can be an alternator or an alternator-starter.

An electrical machine of this type is provided with a control system comprising a synchronous rectifier bridge with a plurality of branches each associated with a phase. Each branch comprises a high transistor which can connect the phase electrically to a positive potential, and a low transistor which can connect the phase electrically to a negative potential of the system.

According to certain conditions, it may be necessary to put the low transistors into a switched-on state in order to short-circuit the phases of the stator temporarily.

Thus, in the event of sudden disconnection of an electrical charge of the on-board network or of a battery, or both, a load-dump phenomenon occurs giving rise to excess voltage on the on-board network. By short-circuiting the phases of the stator, it is possible to limit the voltage on the on-board network to a maximum permissible voltage, i.e. the highest voltage which the electrical equipment of the vehicle can withstand without risk of damage.

In the case of activation of a function for assistance with adjustment of the thermal engine, short-circuiting of the phases of the stator by the command for the low transistors to go to the switched-on state makes it possible to produce losses, and thus to increase the torque collected at low speed from the thermal engine by the rotary electrical machine.

However, in the event when one of the high transistors would be damaged, there is the risk of giving rise to under-voltage on the on-board network by creation of a short-circuit between the positive terminal and the negative terminal of the battery.

Since the consequence of this under-voltage is a loss of power supply to the safety units of the vehicle, there is a need to implement safety mechanisms which make it possible in particular to comply with the level ASIL C of the standard ISO-26262.

The objective of the invention is to fulfil this need by proposing a system for control of a polyphase rotary electrical machine comprising:
a stator provided with a plurality of phases;
a synchronous rectifier bridge with a plurality of branches, each associated with a phase;
each branch comprising a controllable high transistor which can connect the corresponding phase electrically to a positive potential, and a controllable low transistor which can connect the corresponding phase electrically to a negative potential;
a circuit for control of the high transistor, which can control a state of the said high transistor according to a difference between the positive potential and a reference voltage relative to the phase;
a circuit for control of the low transistor, which can control a state of the said low transistor according to a difference between the phase voltage and a reference voltage relative to the negative potential,

characterised in that the control system additionally comprises for each phase a first protection device which is configured to permit a command for the low transistor to go to the switched-on state only if the corresponding phase voltage is lower than a threshold voltage.

The invention thus makes it possible to protect efficiently the rotary electrical machine with synchronous rectification, which is able to command short-circuiting of the phases of the stator, against a risk of under-voltage caused by a short-circuit of a phase at the positive terminal of the alternator. The nature of the invention is also economical, since its implementation involves only slight modifications to the electronic control board.

According to one embodiment, the first protection device comprises a comparator which receives as input the phase voltage and the threshold voltage, with an output of the said comparator controlling a switch which is disposed at the output of a corresponding control device.

According to one embodiment, the threshold voltage is between 50 mV and 300 mV, and is preferably 100 mV.

According to one embodiment, the said system comprises a second protection device which is designed to command a switched-on state of the low transistors, in order to short-circuit the phases when a predetermined function is activated, and the phase voltages are lower than a threshold voltage.

According to one embodiment, the predetermined function is selected from assistance with adjustment of the thermal engine or compensation for load-dump.

According to one embodiment, the second protection device comprises, for each phase, a comparator which receives as input the phase voltage and the threshold voltage, an output of the said comparator being connected to a short-circuit control module.

According to one embodiment, for each phase, the comparator of the second protection device is distinct from the comparator of the first protection device.

According to one embodiment, the second protection device comprises an AND gate which receives as input an output of the short-circuit control module, and information relating to the activation of the predetermined function.

According to one embodiment, an output of the AND gate is connected to switches which control the transition to the switched-on state of the low transistors.

According to one embodiment, the high transistor and the low transistor are of the NMOS type.

According to one embodiment, the said control system comprises a test circuit in order to check the operation of the first protection device and/or the second protection device.

According to one embodiment, the said control system comprises means for communication with a control module of the alternator, in order to take into account latent defects and/or faults of the rectifier bridge which have been detected.

The invention also relates to a rotary electrical machine, characterised in that it comprises a control system as previously defined.

The invention will be better understood by reading the following description and examining the figures which accompany it. These figures are provided purely by way of illustration, and in no way limit the invention.

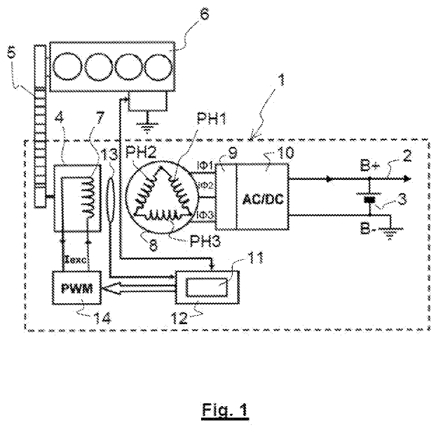

FIG. 1 is a schematic representation of a rotary electrical machine comprising a control system according to the present invention;

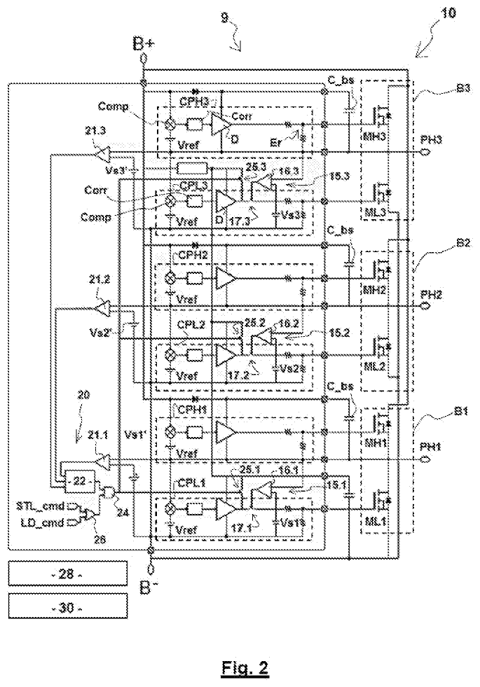

FIG. 2 is a schematic representation of the different components of the control system according to the present invention.

FIG. 1 shows a polyphase rotary electrical machine 1 of the alternator or alternator-starter type, supplying an on-board electrical network 2 connected to a battery 3.

The machine is preferably a machine with excitation 1, a rotor 4 of which is coupled mechanically to a thermal engine 6 of the vehicle by means of a movement transmission device 5, in particular with a belt or chain.

The rotor 4 comprises an excitation circuit 7 through which there passes an excitation current lexc creating in a known manner in a stator 8 with a number n of phases PH1, PH2, PH3, PHn a plurality of phase currents IΦ1, IΦ2, IΦ3, IΦn (n is preferably equal to 3, as represented in FIG. 1, but can be more less than 3).

The machine 1 comprises a synchronous rectifier bridge 10 which is connected to the phase windings PH1-PH3 in order to rectify the phase currents IΦ1, IΦ2, IΦ3 so as to supply the on-board network 2 with direct voltage and charge the battery 3.

The direct voltage is regulated by a regulation device 11 of an electronic control unit 12, which optionally, according to a speed of rotation of the rotor 4 which is determined by a speed sensor 13 and information exchanged with a computer of the thermal engine, controls a duty cycle of the excitation current lexc produced by an excitation module 14.

As can be seen in FIG. 2, the synchronous rectifier bridge 10 has branches B1-B3 each associated with a corresponding phase PH1-PH3. Each branch B1-B3 comprises a controllable high transistor MH1-MH3, which can connect the corresponding phase PH1-PH3 electrically to the positive potential B+, and a controllable low transistor ML1-ML3, which can connect the corresponding phase PH1-PH3 electrically to the negative potential B of the battery 3. The high transistor MH1-MH3 and the low transistor ML1-ML3 are preferably of the same type, in particular of the NMOS type.

A control system 9 comprises a circuit CPH1-CPH3 for control of the high transistor MH1-MH3, which can command a state of the corresponding high transistor MH1-MH3 according to a difference between the positive potential B+ and a reference voltage Vref relative to the phase PH1-PH3. For this purpose, the control circuit CPH1-CPH3 comprises a comparator Comp, a corrector Corr of the PI (Proportional Integral) or PID (Proportional Integral Derivative) type, and a control device D (driver), the output of which is connected to the gate of the high transistor MH1-MH3 by means of a series of resistors Er which make it possible to adapt the current and the impedance according to the characteristics of the transistor MH1-MH3. In addition, a so-called bootstrap capacitor C_bs makes it possible to add an additional voltage to the gate potential, in order to permit the switching of the transistor MH1-MH3.

In addition, a circuit CPL1-CPL3 for control of the low transistor ML1-ML3 can command a state of the corresponding low transistor ML1-ML3 according to a difference between the phase voltage PH1-PH3 and a reference voltage relative to the negative potential B−. For this purpose, the control circuit CPL1-CPL3 comprises a comparator Comp, a corrector Corr of the PI (Proportional Integral) or PID (Proportional Integral Derivative) type, and a control device D (driver), the output of which is connected to the gate of the low transistor ML1-ML3 by means of a series of resistors Er which make it possible to adapt the current and the impedance according to the characteristics of the transistor ML1-ML3.

In normal operation of the alternator 1, the control circuits CPH1-CPH3; CPL1-CPL3 close and open the high and low transistors alternately according to a known operating mode of a synchronous rectifier 10. In the event of excess voltage on the on-board network 2, or during the activation of a function for assistance with adjustment of the thermal engine, one or a plurality of phase windings PH1-PH3 is/are short-circuited. For this purpose, the short-circuiting is carried out by commanding the switched-on state of the low transistors ML1-ML3 in order to establish a short-circuit of the phases PH1-PH3 relative to the potential B−.

The control system 9 also comprises for each phase PH1-PH3 a first protection device 15.1-15.3 which is configured to permit a command for the low transistor ML1-ML3 to go to the switched-on state only if the voltage of the corresponding phase PH1-PH3 is lower than a threshold voltage Vs1-Vs3.

For this purpose, the first protection device 15.1-15.3 comprises a comparator 16.1-16.3 which receives as input the phase voltage PH1-PH3 and the threshold voltage Vs1-Vs3, with an output of the said comparator 16.1-16.3 controlling a switch 17.1-17.3 which is disposed at the output of the control device D of the corresponding control circuit CPL1-CPL3. The switch 17.1-17.3 is advantageously in the form of a transistor for example. The threshold voltage Vs1-Vs3 is between 50 mV and 300 mV, and is preferably 100 mV.

Thus, in the case when the phase voltage PH1-PH3 is lower than the threshold voltage Vs1-Vs3, closure of the switch 17.1-17.3 is commanded, in order to permit a command for the low transistor ML1-ML3 to go into the switched-on state. In the case when the phase voltage PH1-PH3 is higher than the threshold voltage Vs1-Vs3, opening of the switch is commanded, which prevents the command for the low transistor ML1-ML3 to go into the switched-on state.

In addition, the control system 9 comprises a second protection device 20, which is designed to command a switched-on state of the low transistors ML1-ML3 in order to short-circuit the phases PH1-PH3 when a predetermined function is activated, and when the phase voltages PH1-PH3 are lower than a threshold voltage Vs1′-Vs3′. The predetermined function is selected from assistance with adjustment of the thermal engine or compensation for load-dump.

For this purpose, for each phase PH1-PH3, the second protection device 20 comprises a comparator 21.1-21.3 which receives as input the phase voltage PH1-PH3 and the threshold voltage Vs1′-Vs3′, with an output of the said comparator 21.1-21.3 being connected to a short-circuit control module 22. For each phase, the comparator 21.1-21.3 of the second protection device 20 is distinct from the comparator 16.1-16.3 of the first protection device 15.1-15.3, in order to have two systems for protection against short-circuits of the battery 3 which are independent from one another.

In addition, an AND gate 24 receives as input an output of the short-circuit control module 22, and information relating to the activation of the predetermined function. An output of the AND gate 24 is connected to switches 25.1-25.3 which command the transition to the switched-on state of the low transistors ML1-ML3. These switches 25.1-25.3 are advantageously in the form of transistors.

Thus, when the conditions exist to authorise the short-circuiting, i.e. when a demand for adjustment of the thermal engine STL_cmd or a load-dump LD_cmd is detected (cf. OR gate 26), and the phase voltages PH1-PH3 are lower than the threshold voltage Vs1′-Vs3′, then closure of the switches 25.1-25.3 is commanded in order to force the low transistors ML1-ML3 into the switched-on state, and thus generate short-circuiting of the phases.

Advantageously, there is also a test circuit 28 provided to check the operation of the first protection device 15.1-15.3 and/or of the second protection device 20.

Means 30 for communication with a control module of the alternator make it possible to indicate latent defects, and/or faults of the rectifier bridge which have been detected.

It will be appreciated that the foregoing description has been provided purely by way of example, and does not limit the field of the invention, a departure from which would not be constituted by replacing the different elements by any other equivalents.

In addition, the different characteristics, variants and/or embodiments of the present invention can be associated with one another according to various combinations, provided that they are not incompatible or mutually exclusive.

1. A control system for controlling a polyphase rotary electrical machine comprising:
a stator provided with a plurality of phases;
a synchronous rectifier bridge with a plurality of branches, each associated with a phase,
each branch comprising a controllable high transistor which connects the corresponding phase electrically to a positive potential, and a controllable low transistor which connects the corresponding phase electrically to a negative potential;
a circuit for control of the high transistor, which controls a state of the said high transistor according to a difference between the positive potential and a reference voltage relative to the phase;
a circuit for control of the low transistor, which controls a state of the said low transistor according to a difference between the phase voltage and a reference voltage relative to the negative potential; and
for each phase, a first protection device which is configured to permit a command for the low transistor to go to the switched-on state only when the corresponding phase voltage is lower than a threshold voltage.

2. The control system according to claim 1, wherein the first protection device comprises a comparator which receives as input the phase voltage and the threshold voltage, with an output of the said comparator controlling a switch which is disposed at the output of a corresponding control device.

3. The control system according to claim 1, wherein the threshold voltage is between 50 mV and 300 mV.

4. The control system according to claim 2, further comprising: a second protection device configured to command a switched-on state of the low transistors to short-circuit the phases when a predetermined function is activated, and the phase voltages are lower than a threshold voltage.

5. The control system according to claim 4, wherein the predetermined function is selected from assistance with adjustment of the thermal engine or compensation for load-dump.

6. The control system according to claim 4, wherein the second protection device comprises, for each phase, a comparator which receives as input the phase voltage and the threshold voltage, an output of the said comparator being connected to a short-circuit control module.

7. The control system according to claim 6, wherein, for each phase, the comparator of the second protection device is distinct from the comparator of the first protection device.

8. The control system according to claim 6, wherein the second protection device comprises an AND gate which receives as input an output of the short-circuit control module, and information relating to the activation of the predetermined function.

9. The control system according to claim 8, wherein an output of the AND gate is connected to switches which control the transition to the switched-on state of the low transistors.

10. The control system according to claim 1, wherein the high transistor and the low transistor are of the NMOS type.

11. The control system according to claim 1, further comprising a test circuit to check the operation of the first protection device and/or the second protection device.

12. The control system according to claim 1, further comprising means for communication with a control module of the alternator, in order to take into account latent defects and/or faults of the rectifier bridge which have been detected.

13. A rotary electrical machine, comprising: a control system as claimed in claim 1.
